(19) United States
(12) Patent Application Publication
(10) Pub. No.: US 2014/0236498 A1
(43) Pub. Date: Aug. 21, 2014

(54) APPARATUS FOR MONITORING WIND TURBINE BLADE AND METHOD THEREOF

(71) Applicant: Korea Electric Power Corporation, Seoul (KR)

(72) Inventors: Ki Yong Oh, Daejeon (KR); Jae Kyung Lee, Daejeon (KR); Joon Young Park, Daejeon (KR); Jun Shin Lee, Daejeon (KR)

(73) Assignee: KOREA ELECTRIC POWER CORPORATION, Seoul (KR)

(21) Appl. No.: 14/342,356

(22) PCT Filed: Sep. 20, 2012
(86) PCT No.: PCT/KR2012/007563

§ 371 Date: Feb. 28, 2014

(30) Foreign Application Priority Data
Sep. 20, 2012 (KR) 10-2012-0104821

(51) Int. Cl. G01N 19/08

(52) U.S. Cl. CPC G01N 19/08
USPC 702/35

(57) ABSTRACT

Provided are an apparatus and method of monitoring a wind turbine blade. The method includes converting strain of a blade into moment, generating a reference value based on design information of the blade and statistical information of the moment, and comparing the moment with the reference value and determining a state of the blade. Accordingly, since the reference value serving as a reference of blade state determination is generated according to blade design information and moment statistical information and learning of the moment statistical information is performed, reliability of blade state determination can be improved, and thus, effective management and maintenance of the blade becomes possible.

### TECHNICAL FIELD

The present invention relates to an apparatus and method of monitoring a wind turbine blade, and more particularly, to an apparatus and method of monitoring a wind turbine blade capable of generating a reference value, which is a reference of blade state determination, according to blade design information and moment statistical information, and securing reliability of the blade state determination.

### BACKGROUND ART

In general, a wind power generation system is a system of rotating a blade using aerodynamic properties of kinetic energy included in an air flow to convert it into mechanical energy, and rotating a generator using the mechanical energy to obtain electrical energy.

Such a wind power generation system is classified as a horizontal type and a vertical type according to a direction of a rotary shaft with respect to the ground, and is constituted by a rotor having a blade and a hub, a gear box configured to increase a rotational speed to drive a generator, the generator configured to generate electricity, a cooling/heating system configured to properly adjust an operating temperature of each of components, and a power converter system configured to control output.

Among them, when the blade is broken, a down time is increased and exchange cost is also largely consumed. In particular, in a marine wind power generation system, contamination of the blade frequently occurs due to salt, dusts, or the like. Accordingly, a state of the blade should be monitored in real time.

Accordingly, while a sensor is installed at the blade to be used in monitoring the blade, since stationary states and non-stationary states are instantly repeated in the wind power generation unlike another power generation, effective and accurate monitoring cannot be performed.

In addition, in the case of the marine wind power generation, since approach to the blade is limited according to a variation in weather or climate, effective management and maintenance of the blade cannot be performed, and thus, immediate handling cannot be performed upon damage to the blade.

### SUMMARY OF INVENTION

### Technical Problem

In order to solve the problems, an object of the present invention is directed to provide an apparatus and method of monitoring a wind turbine blade capable of securing reliability of blade state determination and performing effective management and maintenance of the blade.

### Solution to Problem

A method of monitoring a wind turbine blade according to an aspect of the present invention includes converting strain of a blade into moment; generating a reference value based on design information of the blade and statistical information of the moment; and comparing the moment with the reference value and determining a state of the blade.

In the present invention, the moment may be converted based on physical properties of a material and shape characteristics of the blade.

In the present invention, the generating of the reference value may include calculating a first reference value based on design information of the blade; calculating a second reference value based on statistical information of the moment; and combining the first reference value and the second reference value to generate the reference value.

In the present invention, the first reference value may be calculated by reflecting a model parameter to a design load of the blade.

In the present invention, the calculating of the second reference value may include calculating a length of a normal section based on an average and standard deviation of the moment; and calculating the second reference value based on the average of the moment and the length of the normal section.

In calculating the length of the normal section of the present invention, the average and standard deviation of the moment may be obtained by reflecting an average and standard deviation of the current time to an average and standard deviation accumulatively calculated to the previous time.

In the present invention, the calculating of the second reference value may include comparing an output of a wind turbine with a rated output when the strain is data measured at a pressure side or a suction side of the blade; and reflecting a variation in output of the wind turbine or a variation in pitch angle of the blade to the statistical information of the moment according to the comparison result.

In the present invention, the variation in output of the wind turbine may be reflected to the statistical information of the moment when the output of the wind turbine is the rated output or less, and the variation in pitch angle of the blade may be reflected to the statistical information of the moment when the output of the wind turbine is larger than the rated output.

In the present invention, the reference value may include a caution reference value for determining a caution state of the blade, a warning reference value for determining a warning state, and an emergency reference value for determining an emergency state.

In the present invention, the method may further include alerting the state of the blade when the state of the blade corresponds to any one of the caution state, the warning state and the emergency state.

An apparatus for monitoring a wind turbine blade according to another aspect of the present invention includes a moment conversion unit configured to convert strain of the wind turbine blade into moment; a state determination unit configured to compare the moment with a reference value and determine a state of the blade; and a reference value generation unit configured to generate the reference value based on design information of the blade and statistical information of the moment.

In the present invention, the moment conversion unit may convert the strain into the moment based on physical properties of a material and shape characteristics of the blade.

In the present invention, the reference value generation unit may combine a first reference value calculated based on design information of the blade and a second reference value calculated based on statistical information of the moment to generate the reference value.

In the present invention, the reference value generation unit may reflect a model parameter to a design load of the blade and calculate the first reference value.

In the present invention, the reference value generation unit may calculate a length of a normal section based on an average and standard deviation of the moment, and calculate the second reference value based on the average of the moment and the length of the normal section.

In the present invention, the reference value generation unit may reflect a variation in output of the wind turbine or a variation in pitch angle of the blade to statistical information of the moment when the strain is data measured at a pressure side or suction side of the blade.

In the present invention, the variation in output of the wind turbine may be reflected to the average and standard deviation of the moment when the output of the wind turbine is a rated output or less, and the variation in pitch angle of the blade may be reflected to the average and standard deviation of the moment when the output of the wind turbine is larger than the rated output.

In the present invention, the reference value may include a caution reference value for determining a caution state of the blade, a warning reference value for determining a warning state, and an emergency reference value for determining an emergency state.

In the present invention, the state determination unit may determine that the state of the blade is the caution state when the moment departs from the caution reference value, determine that the state of the blade is the warning state when the moment departs from the warning reference value, and determine that the state of the blade is the emergency state when the moment departs from the emergency reference value.

In the present invention, the apparatus may further include an alarming unit configured to alert the state of the blade when the state of the blade corresponds to any one of the caution state, the warning state and the emergency state.

### Advantageous Effects of Invention

According to the present invention, since the reference value serving as a reference of blade state determination is generated according to blade design information and moment statistical information, reliability of the blade state determination can be secured in a stationary state and a non-stationary state.

In addition, according to the present invention, since learning of the moment statistical information is performed, a reference value having higher reliability can be generated as the moment statistical information is accumulated, and thus, reliability of the blade state determination can be improved.

As described above, according to the present invention, since the reliability of the blade state determination can be improved, efficient management and maintenance of the blade becomes possible.

### BRIEF DESCRIPTION OF DRAWINGS

FIG. 1 is a view for explaining a position at which strain of a blade is measured at an apparatus for monitoring a wind turbine blade according to an embodiment of the present invention;

FIG. 2 is a block diagram showing a configuration of the apparatus for monitoring the wind turbine blade according to an embodiment of the present invention;

FIG. 3 is a flowchart showing a reference value generating operation of a method of monitoring a wind turbine blade according to an embodiment of the present invention;

FIG. 4 is a view exemplarily showing a reference value and moment measurement data generated by FIG. 3;

FIG. 5 is a flowchart showing a reference value generating operation of the method of monitoring the wind turbine blade according to another embodiment of the present invention;

FIGS. 6 and 7 are views for exemplarily showing a reference value and moment measurement data generated by FIG. 5; and

FIG. 8 is a flowchart showing a blade state determination operation of the method of monitoring the wind turbine blade according to the embodiment of the present invention.

### DESCRIPTION OF EMBODIMENTS

Hereinafter, an apparatus and method of monitoring a wind turbine blade according to the present invention will be described in detail with reference to the accompanying drawings. In this process, thicknesses of lines, sizes of components, or the like, shown in the drawings may be exaggerated for the clarity and convenience of description. In addition, terms, which are to be described below, are defined in consideration of functions in the present invention, and may be changed according to intention or custom of a user or an operator. Accordingly, definitions of the terms will be provided based on the entire contents throughout the specification.

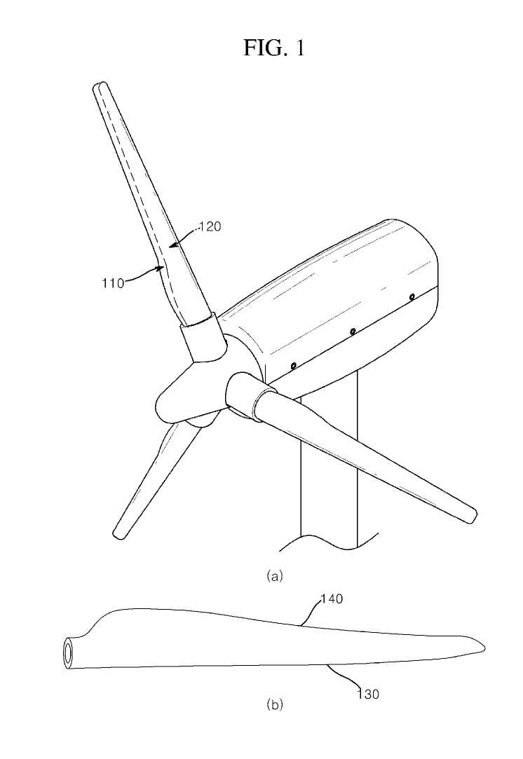

FIG. 1 is a view for explaining a position at which strain of a blade is measured at an apparatus for monitoring a wind turbine blade according to an embodiment of the present invention.

As shown in FIG. 1, in general, points at which strain measurement is performed at the blade are classified into a pressure side 110, a suction side 120, a leading edge 130 and a trailing edge 140.

Here, the pressure side 110 means a front surface of the blade configured to receive wind, and the suction side 120 means a rear surface of the blade that does not receive wind. The leading edge 130 and the trailing edge 140 correspond to corner points of the pressure side 110 and the suction side 120 and receive rotary moment.

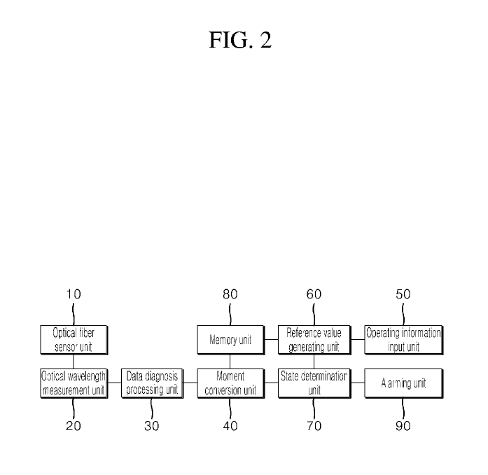

FIG. 2 is a block diagram showing a configuration of the apparatus for monitoring the wind turbine blade according to the embodiment of the present invention.

As shown in FIG. 2, the apparatus for monitoring the wind turbine blade according to the embodiment of the present invention includes an optical fiber sensor unit 10, an optical wavelength measurement unit 20, a data diagnosis processing unit 30, a moment conversion unit 40, an operating information input unit 50, a reference value generation unit 60, a state determination unit 70, a memory unit 80 and an alarming unit 90.

The optical fiber sensor unit 10 includes a plurality of wavelength-division multiplexing (WDM) optical fiber sensors, and each optical fiber sensor reflects a laser radiated from a light source (not shown) at a specific wavelength and transmits the laser to the optical wavelength measurement unit 20.

Referring to FIG. 1, the plurality of optical fiber sensors may be installed at the pressure side 110, the suction side 120, the leading edge 130 and the trailing edge 140 of the blade at 90° intervals.

The optical wavelength measurement unit 20 measures a wavelength reflected from the optical fiber sensor unit 10 to generate a plurality of measurement data, and transmits the data to the data diagnosis processing unit 30.

Here, optical wavelength measurement unit 20 can generate measurement data at every measurement period, and the measurement period maybe variously selected according to intention of a designer and specification of the optical fiber sensor and the optical wavelength measurement unit 20. For example, the optical wavelength measurement unit 20 can generate measurement data at every 0.01 used (i.e., 100 [Hz]) to transmit the date to the data diagnosis processing unit 30.

The data diagnosis processing unit 30 diagnoses whether error data are present in the plurality of measurement data input from the optical wavelength measurement unit 20, and converts the diagnosed measurement data into strain, which is physical data, to transmit the strain to the moment conversion unit 40.

The moment conversion unit 40 converts the strain input from the data diagnosis processing unit 30 into equivalent moment to transmit the moment to the state determination unit 70.

In this case, the moment conversion unit 40 can reflect physical properties (E) of a material and shape characteristics (I_{ZZ}, y) of the blade to the strain (ε) and converts them into moment (M) according to Math. 1.

$$M = - \frac{ɛ \cdot {EI}_{ZZ}}{y} \qquad [ Math . 1 ]$$

Here, M represents moment, ε represents strain, E represents physical properties of a material, I_{ZZ} represents inertia moment, y represents a root of a radius of rotation r (i.e., \sqrt{r}), which is geometric information.

Since load interpretation of the wind turbine is performed in units of moment, the measured strain is converted into moment to be used for blade state determination.

The moment converted by the moment conversion unit 40 is stored in the memory unit 80 to be used to generate statistical information of the next moment, which will be described below in detail.

The operating information input unit 50 receives the operating information of the wind turbine to transmit the operating information to the reference value generation unit 60. Here, the operating information includes information about output (power) of the wind turbine and a pitch angle of the blade.

The reference value generation unit 60 generates a reference value based on the design information of the blade and the statistical information of the moment converted by the moment conversion unit 40, and provides the reference value to the state determination unit 70.

Here, the reference value generation unit 60 can calculate a first reference value based on the design information of the blade and calculate a second reference value based on the statistical information of the moment, and then, combine the first reference value and the second reference value according to a weight to generate a final reference value.

The design information of the blade may include the design load of the blade determined in units of moment, and the design load may include a maximum design load and a minimum design load.

The statistical information of the moment may include an average and standard deviation of the moment, and the average and the standard deviation of the moment can be calculated from a plurality of moment values sequentially stored in the memory unit 80 from the moment conversion unit 40.

In addition, the reference value means a value, which is a reference of the blade state determination, and may be constituted by a plurality of reference values according to a method of defining a state of the blade.

For example, when the states of the blade are defined as a stationary state, a caution state, a warning state and an emergency state according to an error level, the reference value may be constituted by a caution reference value for determining whether the state is the caution state, a warning reference value for determining whether the state is the warning state, and an emergency reference value for determining whether the state is the emergency state.

Meanwhile, in generating the second reference value based on the statistical information of the moment, the reference value generation unit 60 can generate a reference value in different methods according to a position at which the strain of the blade is measured.

Specifically, when the positions at which the strain is measured are the pressure side 110 and the suction side 120 of the blade, the reference value generation unit 60 can reflect the output of the wind turbine and the pitch angle of the blade input from the operating information input unit 50 to the statistical information of the moment to calculate the second reference value.

Since the pressure side 110 and the suction side 120 of the blade are affected by a thrust force differently from the leading edge 130 and the trailing edge 140 of the blade, the pressure side 110 and the suction side 120 have characteristics depending on the output of the wind turbine and the pitch angle of the blade.

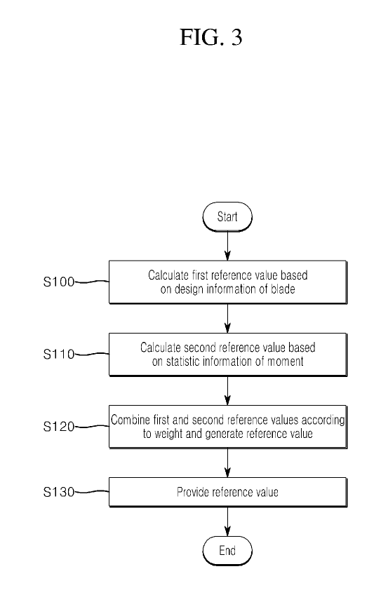

As described above, a specific process of generating a reference value using the reference value generation unit 60 will be described in detail with reference to FIGS. 3 to 7.

The state determination unit 70 compares the moment input from the moment conversion unit 40 with the reference value provided from the reference value generation unit 60 to determine the state of the blade.

For example, when the reference value includes the caution reference value, the warning reference value and the emergency reference value, the state determination unit 70 can compare the moment with the caution reference value, the warning reference value and the emergency reference value to determine which of the stationary state, the caution state, the warning state and the emergency state is the state of the blade.

When it is determined that the blade corresponds to any one state of the caution state, the warning state and the emergency state, the state determination unit 70 can control the alarming unit 90 to perform an appropriate alert.

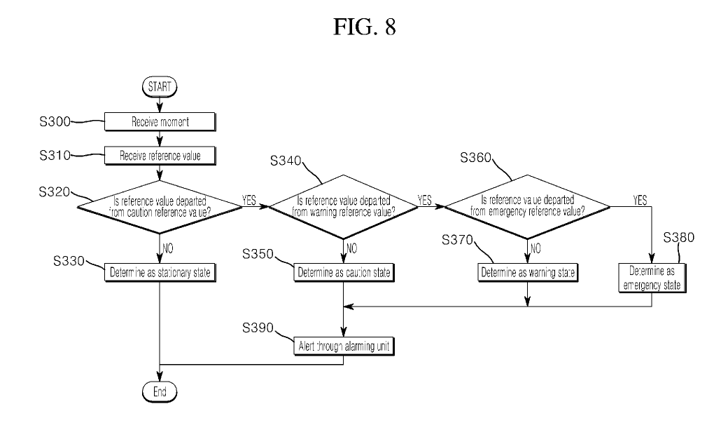

As described above, the specific process of determining the state of the blade and controlling the alarming unit 90 using the state determination unit 70 will be described below with reference to FIG. 8.

The moments converted by the moment conversion unit 40 is sequentially stored in the memory unit 80 according to a measurement time.

The alarming unit 90 outputs information of the state of the blade according to the control of the state determination unit 70. For example, the alarming unit 90 can output information of the stationary state, the caution state, the warning state and the emergency state of the blade.

The alarming unit 90 can display and output the state of the blade through a warning lamp (not shown) or a display panel (not shown), or output the state of the blade using sound through a speaker (not shown) or the like.

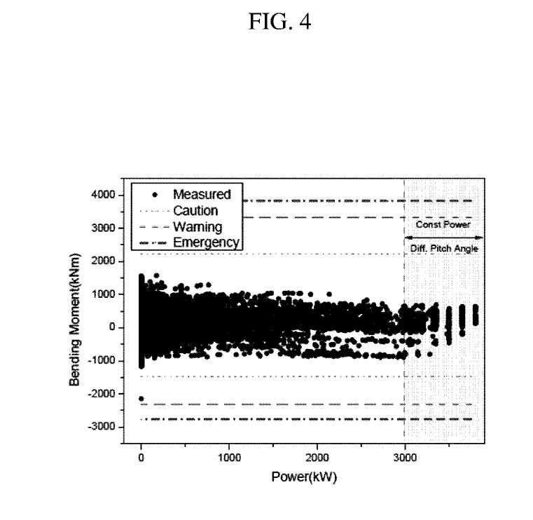

FIG. 3 is a flowchart showing a reference value generating operation of a method of monitoring a wind turbine blade according to an embodiment of the present invention, and FIG. 4 is a view exemplarily showing a reference value and moment measurement data generated by FIG. 3.

FIG. 3 shows a process of generating a reference value using the reference value generation unit 60 when a strain measurement position is the leading edge 130 and the trailing edge 140 of the blade.

As shown in FIG. 3, first, the reference value generation unit 60 calculates a first reference value based on design information of the blade (S100).

Specifically, the reference value generation unit 60 can reflect a model parameter to a maximum design load and a minimum design load of the blade to calculate a first reference value.

For example, when the first reference value includes a first caution reference value, a first warning reference value and a first emergency reference value, the first caution reference value (C₁₋ₘₐₓ, C₁₋ₘᵢₙ), the first warning reference value (W₁₋ₘₐₓ, W₁₋ₘᵢₙ) and the first emergency reference value (E₁₋ₘₐₓ, E₁₋ₘᵢₙ) can be calculated according to the following Math. 2 to Math. 4.

C₁₋ₘₐₓ=v₁·M_{D-max},C₁₋ₘᵢₙ=v₂·M_{D-min} [Math. 2]

W₁₋ₘₐₓ=v₃·M_{D-max},W₁₋ₘᵢₙ=v₄·M_{D-min} [Math. 3]

E₁₋ₘₐₓ=v₅·M_{D-max},E₁₋ₘᵢₙ=v₆·M_{D-min} [Math. 4]

Here, M_{D-max} and M_{D-min} represent a maximum design load and a minimum design load of the blade, respectively, and v₁ to v₆ represent model parameters. The model parameters are parameters multiplied by the maximum design load and the minimum design load, which may be selected as a value corresponding to 1σ, 2σ and 3σ on standard normal distribution of the design load.

For example, v₁ and v₂ may be selected as 0.68 corresponding to 1σ, v₃ and v₄ may be selected as 0.95 corresponding to 2σ, and v₅ and v₆ may be selected as 0.99 corresponding to 3σ. However, these are merely exemplary and the model parameters may be selected as various values according to intention of a designer or specification of an applied blade.

Meanwhile, the reference value generation unit 60 calculates a second reference value based on statistical information of moment (S110).

Specifically, the reference value generation unit 60 can calculate a length (normal distance; L) of a normal section based on an average and standard deviation of the moment, and calculate the second reference value based on the average of the moment and the length L of the normal section.

For example, when the second reference value includes a second caution reference value, a second warning reference value and a second emergency reference value, the second caution reference value (C₂₋ₘₐₓ, C₂₋ₘᵢₙ), the second warning reference value (W₂₋ₘₐₓ, W₂₋ₘᵢₙ) and the second emergency reference value (E₂₋ₘₐₓ, E₂₋ₘᵢₙ) may be calculated according to the following Math. 5 to Math. 7.

C₂₋ₘₐₓ=M_{avg}+s₁·L,C₂₋ₘᵢₙ=M_{avg}−s₂·L [Math. 5]

W₂₋ₘₐₓ=M_{avg}+s₃·L,W₂₋ₘᵢₙ=M_{avg}−s₄·L [Math. 6]

E₂₋ₘₐₓ=M_{avg}+s₅·L,E₂₋ₘᵢₙ=M_{avg}−s₆·L [Math. 7]

Here, M_{avg} represents an average of the moment, L represents a length of the normal section, and s₁ to s₆ represent statistic parameters.

The statistic parameters are parameters multiplied by the length of the normal section, like the above-mentioned model parameter, which may be selected as a value corresponding to 1σ, 2σ and 3σ on standard normal distribution of the moment. However, these are merely exemplary and the statistic parameters may be selected as various values according to intention of a designer or specification of the applied blade.

Meanwhile, the length L of the normal section is a value for substantially determining the second reference value, which is calculated based on the average and the standard deviation of the moment.

The reference value generation unit 60 can add the average and the standard deviation of the moment multiplied by proportional constants k₁ and k₂ to calculate the length L of the normal section according to the following Math. 8.

L=k₁·M_{avg}+k₂·σ_{M} [Math. 8]

Here, M_{avg} and σ_{M} represent the average and the standard deviation of the moment, respectively, and k₁ and k₂ represent proportional constants. The proportional constants k₁ and k₂ may be variously selected according to intention of a designer. For example, k₁ and k₂ may be selected as 0.1 and 0.9, respectively.

Meanwhile, the reference value generation unit 60 can add the average and standard deviation accumulatively calculated to the current time and multiplied by the proportional constants k₁ and k₂ to calculate the length L of the normal section according to the following Math. 9.

L=k₁·M_{avg}(t)+k₂·σ_{avg}(f) [Math. 9]

Here, M_{avg}(t) and σ_{avg}(t) represent the accumulatively calculated average and standard deviation of the moment, and k₁ and k₂ represent the proportional constants.

In this case, the average and standard deviation of the moment accumulatively calculated to the current time may have the moment and standard deviation to the current time reflected to the average and standard deviation of the moment accumulatively calculated to the previous time according to the following Math. 10 and Math. 11.

$$\begin{matrix}{M}_{avg} ( t ) = \frac{( t - 1 ) \cdot {M}_{avg} ( t - 1 ) + M ( t )}{t} & [ Math . 10 ] \\ {σ}_{avg} ( t ) = \frac{( t - 1 ) \cdot {σ}_{avg} ( t - 1 ) + σ ( t )}{t} & [ Math . 11 ]\end{matrix}$$

Here, M_{avg}(t) and σ_{avg}(t) represent the average and standard deviation of the moment accumulatively calculated to the current time, M_{avg}(t−1) and σ_{avg}(t−1) represent the average and standard deviation of the moment accumulatively calculated to the previous time, and M(t) and σ(t) represent the moment and standard deviation of the current time.

For reference, σ_{avg}(t) may be calculated according to the following Math. 12.

$${σ}_{avg} ( t ) = \sqrt{\frac{\sum {M ( t )}^{2} - t \cdot {{M}_{avg} ( t )}^{2}}{t}} \qquad [ Math . 12 ]$$

As described above, when learning of the moment statistical information is performed, a reference value having higher reliability can be generated as the moment statistical information is accumulated, and thus, reliability of the blade state determination can be improved.

Referring to FIG. 3 again, the reference value generation unit 60 combines the first reference value and the second reference value according to the weight and generates a final reference value according to the following Math. 13 (S120), and provides the final reference value to the state determination unit 70 (S130).

For example, when the reference value includes the caution reference value, the warning reference value and the emergency reference value, the caution reference value (Cₘₐₓ, Cₘᵢₙ), the warning reference value (Wₘₐₓ, Wₘᵢₙ) and the emergency reference value (Eₘₐₓ, Eₘᵢₙ) can be calculated according to the following Math. 13 to Math. 15, respectively.

Cₘₐₓ=w₁·C₁₋ₘₐₓ+w₂·C₂₋ₘₐₓ,Cₘᵢₙ=w₁·C₁₋ₘᵢₙ+w₂·C₂₋ₘᵢₙ [Math. 13]

Wₘₐₓ=w₁·W₁₋ₘₐₓ+w₂·W₂₋ₘₐₓ,Wₘᵢₙ=w₁·W₁₋ₘᵢₙ+w₂·W₂₋ₘᵢₙ [Math. 14]

Eₘₐₓ=w₁·E₁₋ₘₐₓ+w₂·E₂₋ₘₐₓ,Eₘᵢₙ=w₁·E₁₋ₘᵢₙ+w₂·E₂₋ₘᵢₙ [Math. 15]

Here, w₁ and w₂ represent weights multiplied by the first reference value and the second reference value, respectively.

The caution reference value, the warning reference value, the emergency reference value and the moment measurement data generated through the series of processes are shown in FIG. 4. It will be appreciated that, since the leading edge 130 and the trailing edge 140 of the blade have points at which the rotary moment is received, an influence on the output of the wind turbine or the variation in pitch angle of the blade is not reflected.

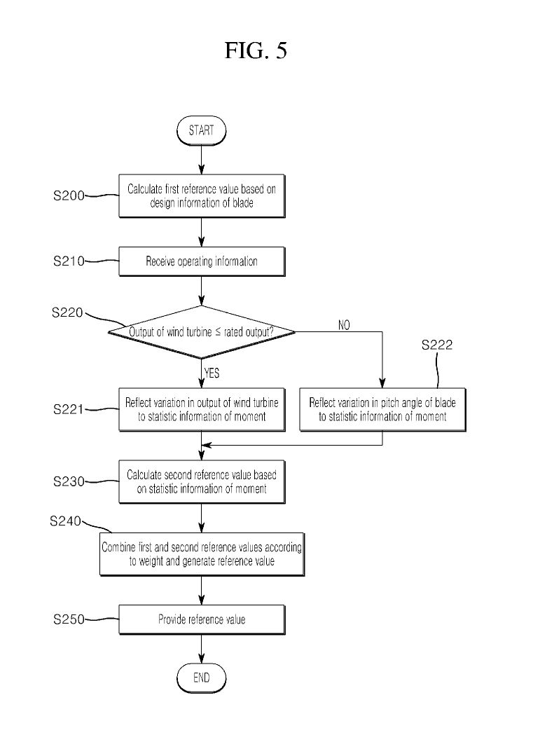

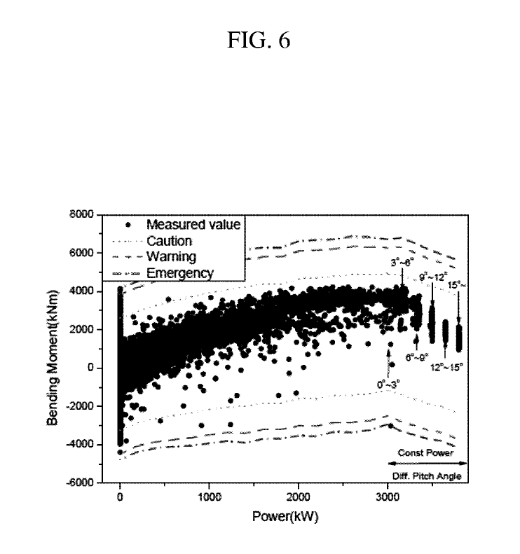

On the other hand, the pressure side 110 and the suction side 120 of the blade receive an influence of the output of the wind turbine and the pitch angle of the blade, and the reference value generating operation in this case will be described with reference to FIGS. 5 and 6.

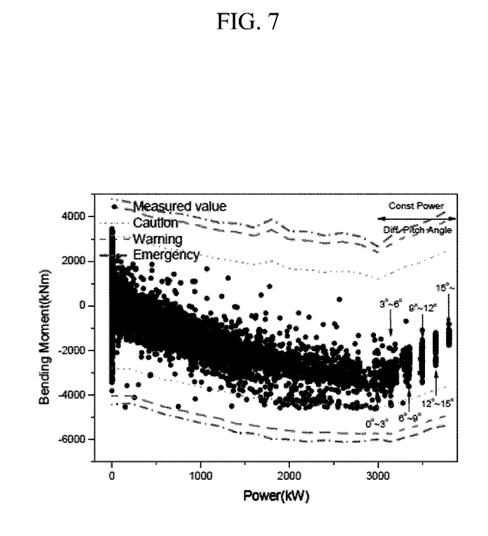

FIG. 5 is a flowchart showing a reference value generating operation of a method of monitoring a wind turbine blade according to another embodiment of the present invention, and FIGS. 6 and 7 are views for exemplarily showing a reference value and moment measurement data generated by FIG. 5.

FIG. 5 shows a process of generating a reference value using the reference value generation unit 60 when a strain measurement position is the pressure side 110 and the suction side 120 of the blade, and the process will be described with reference to FIG. 5 with focusing differences from the above-mentioned embodiment.

As shown in FIG. 5, first, the reference value generation unit 60 calculates a first reference value based on design information of the blade (S200). Since the step is the same as S100 of the embodiment described with reference to FIG. 3, detailed description thereof will be omitted.

Next, the reference value generation unit 60 receives operating information of the wind turbine from the operating information input unit 50 (S210). Here, the operating information includes information of output of the wind turbine and a pitch angle of the blade.

Next, the reference value generation unit 60 compares the output of the wind turbine with a rated output, and determines whether the output of the wind turbine is the rated output or less (S220).

When the output of the wind turbine is the rated output or less, since the moment is varied depending on the output of the wind turbine, the reference value generation unit 60 reflects a variation in output of the wind turbine to the statistical information of the moment (S221).

On the other hand, when the output of the wind turbine is larger than the rated output, since the moment is varied depending on the pitch angle of the blade, the reference value generation unit 60 reflects the variation in pitch angle of the blade to the statistical information of the moment (S222).

Next, the reference value generation unit 60 calculates a second reference value based on the statistical information of the moment to which the variation in output of the wind turbine or the variation in pitch angle of the blade (S230).

Specifically, the reference value generation unit 60 can calculates a length (a normal distance; L) of a normal section based on the average and standard deviation of the moment to which the variation in output of the wind turbine or the variation in pitch angle of the blade is reflected, and calculate the second reference value based on the average of the moment to which the variation in output of the wind turbine or the variation in pitch angle of the blade is reflected and the length L of the normal section.

For example, when the output of the wind turbine is the rated output or less and the second reference value includes a second caution reference value, a second warning reference value and a second emergency reference value, the second caution reference value (C₂₋ₘₐₓ, C₂₋ₘᵢₙ), the second warning reference value (W₂₋ₘₐₓ, W₂₋ₘᵢₙ) and the second emergency reference value (E₂₋ₘₐ, E₂₋ₘᵢₙ) can be calculated according to the following Math. 16 to Math. 18, respectively.

C₂₋ₘₐₓ(p)=M_{avg}(p)+s₁·L(p),C₂₋ₘᵢₙ(p)=M_{avg}(p)−s₂·L(p) [Math. 16]

W₂₋ₘₐₓ(p)=M_{avg}(p)+s₃·L(p),W₂₋ₘᵢₙ(p)=M_{avg}(p)−s₄·L(p) [Math. 17]

E₂₋ₘₐₓ(p)=M_{avg}(p)+s₅·L(p),E₂₋ₘᵢₙ(p)=M_{avg}(p)−s₆·L(p) [Math. 18]

Here, M_{avg} represents the average of the moment, L represents the length of the normal section, and s₁ to s₆ represent statistic parameters. In addition, p refers to a parameter representing the output of the wind turbine.

If a parameter θ representing the pitch angle of the blade is substituted with the parameter P when the output of the wind turbine is larger than the rated output, the second caution reference value, the second warning reference value and the second emergency reference value can be calculated through the same method.

Meanwhile, since a method of calculating the length L of the normal section is similar to the embodiment described with reference to FIG. 3 except that the average and the standard deviation of the moment are represented as a function of p or θ, detailed description thereof will be omitted.

Since the reference value generation unit 60 combines the first reference value and the second reference value according to the weight to generate a final reference value and providing the final reference value to the state determination unit 70 (S240 and S250) is also substantially equal to S120 and S130 of the embodiment with respect to FIG. 3, detailed description thereof will be omitted.

Meanwhile, the caution reference value, the warning reference value, the emergency reference value and the moment measurement data generated through the above-mentioned processes are shown in FIGS. 6 and 7. FIG. 6 shows a reference value and moment measurement data with respect to the pressure side 110, and FIG. 7 shows a reference value and moment measurement data with respect to the suction side 120.

As described above, when the reference value serving as a reference of the blade state determination is generated according to the blade design information and the moment statistical information, reliability of the blade state determination in the stationary state and the non-stationary state can be secured.

FIG. 8 is a flowchart showing a blade state determination operation of the method of monitoring the wind turbine blade according to the embodiment of the present invention.

As shown in FIG. 8, the state determination unit 70 receives the moment from the moment conversion unit 40 (S300) and receives the reference value from the reference value generation unit 60 (S310).

Here, the reference value may include a caution reference value for determining whether the caution state is present, a warning reference value for determining whether the warning state is present, and an emergency reference value for determining whether the emergency state is present.

Next, the state determination unit 70 compares the moment with the reference value to determine the state of the blade.

Specifically, the state determination unit 70 checks whether the moment departs from an upper limit value or a lower limit value of the caution reference value (S320), and determines that the state of the blade is the stationary state when the moment corresponds to a value between the upper limit value and the lower limit value of the caution reference value (S330).

On the other hand, when the moment departs from the upper limit value or the lower limit value of the caution reference value, the state determination unit 70 determines whether the moment departs from the upper limit value or the lower limit value of the warning reference value (S340).

When the moment corresponds to a value between the upper limit value and the lower limit value of the warning reference value, the state determination unit 70 determines that the state of the blade is the caution state (S350).

However, when the moment departs from the upper limit value or the lower limit value of the warning reference value, the state determination unit 70 determines whether the moment departs from the upper limit value or the lower limit value of the emergency reference value (S360).

When the moment corresponds to a value between the upper limit value and the lower limit value of the emergency reference value, the state determination unit 70 determines that the state of the blade is the warning state (S370).

However, when the moment departs from the upper limit value or the lower limit value of the warning reference value, the state determination unit 70 determines that the state of the blade is the emergency state (S380).

As described above, when the state of the blade is determined as the caution state, the warning state or the emergency state, the state determination unit 70 controls the alarming unit 90 to perform an appropriate alert (S390).

As described above, according to the apparatus and method of monitoring the wind turbine blade of the present invention, since the reference value serving as a reference of the blade state determination is generated according to the blade design information and moment statistical information, reliability of the blade state determination in the stationary state and the non-stationary state can be secured.

In addition, since the learning of the moment statistical information is performed, the reference value having higher reliability can be generated as the moment statistical information is accumulated, and reliability of the blade state determination can be further improved. Accordingly, effective management and maintenance of the blade can be performed.

It will be apparent to those skilled in the art that various modifications can be made to the above-described exemplary embodiments of the present invention without departing from the spirit or scope of the invention. Thus, it is intended that the present invention covers all such modifications provided they come within the scope of the appended claims and their equivalents.

1. A method of monitoring a wind turbine blade, comprising:
converting strain of a blade into moment;
generating a reference value based on design information of the blade and statistical information of the moment; and
comparing the moment with the reference value and determining a state of the blade.

2. The method according to claim 1, wherein the moment is converted based on physical properties of a material and shape characteristics of the blade.

3. The method according to claim 1, wherein the generating of the reference value comprises:
calculating a first reference value based on design information of the blade;
calculating a second reference value based on statistical information of the moment; and
combining the first reference value and the second reference value to generate the reference value.

4. The method according to claim 3, wherein the first reference value is calculated by reflecting a model parameter to a design load of the blade.

5. The method according to claim 3, wherein the calculating of the second reference value comprises:
calculating a length of a normal section based on an average and standard deviation of the moment; and
calculating the second reference value based on the average of the moment and the length of the normal section.

6. The method according to claim 5, wherein, in calculating the length of the normal section, the average and standard deviation of the moment are obtained by reflecting an average and standard deviation of the current time to an average and standard deviation accumulatively calculated to the previous time.

7. The method according to claim 3, wherein the calculating of the second reference value comprises:
comparing an output of a wind turbine with a rated output when the strain is data measured at a pressure side or a suction side of the blade; and
reflecting a variation in output of the wind turbine or a variation in pitch angle of the blade to the statistical information of the moment according to the comparison result.

8. The method according to claim 7, wherein the variation in output of the wind turbine is reflected to the statistical information of the moment when the output of the wind turbine is the rated output or less, and
the variation in pitch angle of the blade is reflected to the statistical information of the moment when the output of the wind turbine is larger than the rated output.

9. The method according to claim 1, wherein the reference value comprises a caution reference value for determining a caution state of the blade, a warning reference value for determining a warning state, and an emergency reference value for determining an emergency state.

10. The method according to claim 1, further comprising alerting the state of the blade when the state of the blade corresponds to any one of the caution state, the warning state and the emergency state.

11. An apparatus for monitoring a wind turbine blade, comprising:
a moment conversion unit configured to convert strain of the wind turbine blade into moment;
a state determination unit configured to compare the moment with a reference value and determine a state of the blade; and
a reference value generation unit configured to generate the reference value based on design information of the blade and statistical information of the moment.

12. The apparatus according to claim 11, wherein the moment conversion unit converts the strain into the moment based on physical properties of a material and shape characteristics of the blade.

13. The apparatus according to claim 11, wherein the reference value generation unit combines a first reference value calculated based on the design information of the blade and a second reference value calculated based on the statistical information of the moment to generate the reference value.

14. The apparatus according to claim 13, wherein the reference value generation unit reflects a model parameter to a design load of the blade and calculates the first reference value.

15. The apparatus according to claim 13, wherein the reference value generation unit calculates a length of a normal section based on an average and standard deviation of the moment, and calculates the second reference value based on the average of the moment and the length of the normal section.

16. The apparatus according to claim 13, wherein the reference value generation unit reflects a variation in output of the wind turbine or a variation in pitch angle of the blade to the statistical information of the moment when the strain is data measured at a pressure side or suction side of the blade.

17. The apparatus according to claim 16, wherein the variation in output of the wind turbine is reflected to the average and standard deviation of the moment when the output of the wind turbine is a rated output or less, and
the variation in pitch angle of the blade is reflected to the average and standard deviation of the moment when the output of the wind turbine is larger than the rated output.

18. The apparatus according to claim 11, wherein the reference value comprises a caution reference value for determining a caution state of the blade, a warning reference value for determining a warning state, and an emergency reference value for determining an emergency state.

19. The apparatus according to claim 18, wherein the state determination unit determines that the state of the blade is the caution state when the moment departs from the caution reference value, determines that the state of the blade is the warning state when the moment departs from the warning reference value, and determines that the state of the blade is the emergency state when the moment departs from the emergency reference value.

20. The apparatus according to claim 18, further comprising an alarming unit configured to alert the state of the blade when the state of the blade corresponds to any one of the caution state, the warning state and the emergency state.
